(19) United States
(12) Patent Application Publication
(10) Pub. No.: US 2025/0355794 A1
(43) Pub. Date: Nov. 20, 2025

(54) COMPLEX VALUED SPARSE DISTRIBUTED MEMORIES

(71) Applicant: Hewlett Packard Enterprise Development LP, Spring, TX (US)

(72) Inventors: Ron M. Roth, Haifa (IL); Aishwarya Natarajan, Milpitas, CA (US); Giacomo Pedretti, San Francisco, CA (US)

(21) Appl. No.: 18/669,039

(22) Filed: May 20, 2024

(51) Int. Cl. G06F 12/02

(52) U.S. Cl. CPC G06F 12/0223

(57) ABSTRACT

In certain examples, a method includes obtaining a SDM word to be written to a contents matrix; obtaining an address corresponding to the SDM word; determining a set of activated address rows of an address matrix using the address; selecting a set of activated contents matrix rows of the contents matrix based on the set of activated address rows; calculating a complex value based on an element of the SDM word, wherein an element position of the element corresponds to a contents matrix column pair of the contents matrix; and for each row of the set of activated contents matrix rows: modifying a real component value of a first column of the contents matrix column pair based on a real part of the complex value; and modifying an imaginary component value of a second column of the contents matrix column pair based on an imaginary part of the complex value.

### CROSS-REFERENCE TO RELATED APPLICATIONS

Data may be organized in a variety of ways and stored in a variety of ways by computing devices. To store the data, the data is often organized into data structures. Data may be written to such data structures, and may subsequently be read from such data structures. Thus, components of computing devices are often configured to include data structures to which data is written and from which data is read.

### BRIEF DESCRIPTION OF THE DRAWINGS

Certain examples discussed herein will be described with reference to the accompanying drawings listed below. However, the accompanying drawings illustrate only certain aspects or implementations of examples described herein by way of example, and are not meant to limit the scope of the claims.

FIG. 1 illustrates a block diagram of an example system for implementing complex valued sparse distributed memory (CV-SDM) techniques in accordance with one or more examples disclosed herein;

FIG. 2 illustrates an overview of an example method 200 for writing a sparse distributed memory (SDM) word to a contents matrix in accordance with one or more examples disclosed herein;

FIG. 3 illustrates an overview of an example method 300 for reading a SDM word from a contents matrix in accordance with one or more examples disclosed herein;

FIG. 4A-FIG. 4G illustrate an example of writing and reading a SDM word using CV-SDM techniques, in accordance with one or more examples disclosed herein; and

FIG. 5 illustrates a block diagram of a computing device, in accordance with one or more examples disclosed herein.

The figures are drawn to illustrate various aspects of the disclosure and are not necessarily drawn to scale.

### DESCRIPTION

Hyperdimensional computing may refer to an approach to computation in which data is represented by hyperdimensional vectors, which may have large quantities of vector elements (e.g., thousands), that exist in high-dimensional spaces. Machine learning (ML) models built upon hyperdimensional concepts are often robust, relatively easy to train, and less sensible to precision issues, making such models, for example, well-suited for edge computing, where small accelerators with limited precision are easier to deploy. In such a framework, Sparse Distributed Memory (SDM) is a memory representation that allows for the representation of a very large space (e.g., an n-dimensional space) with a limited number of physical storage locations for storing vectors of information, which may be referred to herein as SDM words. Such models may have a variety of applications (e.g., image recognition, natural language processing, bio-signal processing, robotics, best-match searches, statistical prediction, and the like). In one or more examples, SDM may be considered a mathematical model for long-term memory (e.g., human memory). SDM may use relatively long (e.g., 1000 element) words to represent information in an n-dimensional space.

However, conventional SDM implementations represent data using binary numbers (e.g., 0 or 1) as elements of a vector (e.g., a Boolean vector) having n elements, which may present challenges when representing real-world data that may not be easily represented using a binary representation. Certain techniques may be used to improve SDM schemes. One such technique is an Integer SDM (ISDM) technique, in which integers, rather than binary numbers, are used as elements of a vector to represent information in a large dimensional space. ISDM techniques may use integers in a set of r positive integers to represent information, which may be better suited for real-world data that is not always easily represented by binary numbers.

However, with ISDM techniques, a large hardware overhead may be required to store large vector representations of data that include integer values as elements. As an example, if a set of integers r are used as possible values for each value k of a vector having n elements k, storing each element in a vector of integer elements may require a storage component for each element of the vector that includes r index locations, with one index location for each possible value from zero to r−1 (e.g., when r=4, an index location for 0, 1, 2, and 3 for each element k of the n elements of the vector). Thus, storing such a vector of integer values may require a quantity of r*n storage components, with n being the number of elements in the vector, and r being the set of possible integer values of any given element.

In order to address, at least in part, the aforementioned challenges, including challenges related to the amount of hardware required to store and retrieve (e.g., write and read) SDM and/or ISDM representations of information, examples described herein include techniques for implementing a complex number representation for values of ISDM vectors (which may be referred to herein as SDM words), thereby creating a complex valued sparse distributed memory (CV-SDM) storage technique for writing and reading such vectors. In one or more examples, the CV-SDM techniques disclosed herein may significantly reduce the amount of storage needed to store ISDM representations of information, while maintaining the benefits of using ISDM techniques instead of binary data SDM techniques in regards to the data that may be represented. As an example, the amount of storage elements required to store such vectors may be reduced from r*n (as with an ISDM scheme) to 2*n, where n remains the number of elements of the vector, and the two is for the real and imaginary components of each element (e.g., as opposed to r index positions for each of n values in ISDM).

In one or more examples, a vector may have elements k, and there may be n such elements, each having a value of any one of r possible integer values. Thus, each element k may be represented as a complex number φ(k) having a real part, calculated by the cosine of [(2*π*k) divided by r], and an imaginary part, calculated by the imaginary unit i multiplied by the sine of [(2*π*k) divided by r], which may also be shown as:

$$φ ( k ) = cos ( \frac{2 π k}{r} ) + i sin ( \frac{2 π k}{r} )$$

Thus, for example, if a vector to represent information using a set of integer elements k, and each element k may be any one of r values where r is equal to 4 (e.g., k is one of four values: zero, one, two, or three), the above equation would yield the following as real and imaginary parts of the values of k being 0, 1, 2, or 3:

| k | Real part of φ(k) | Imaginary part of Real part of φ(k) |
|---|---|---|
| 0 | 1 | 0 |
| 1 | 0 | 1 |
| 2 | −1 | 0 |
| 3 | 0 | −1 |

In one or more examples, to store a representation of a vector having a quantity n of elements k, where each element is any of a of r different integers, may be achieved by storing the real and imaginary parts of the r value of each element of k for the n elements of the vector, meaning that the vector may be stored using 2*n storage locations, representing an improvement over the aforementioned ISDM techniques that require r*n storage elements, while maintaining the benefits of using decimal integers rather than binary numbers to represent information.

In one or more examples, to store a vector having n elements, the vector may be considered a SDM word that is to be stored in a contents matrix, and possibly later read from the contents matrix. Each row in the contents matrix may correspond to a unique address represented in a corresponding address matrix having the same number of rows as the contents matrix. An address may be either the same (e.g., have the same vector element values) as the actual data (e.g., the vector that is the input word to be written to the contents matrix), as in an auto-associative memory technique, or different, as in a hetero-associative memory technique. In one or more examples, the address matrix stores a set of addresses as hard locations, which may be uniformly distributed within a high-dimensional virtual space, thereby mimicking the existence of the virtual space.

In either case, to store a SDM word (e.g., a vector having n elements) using examples disclosed herein, a particular address may be used as the address for storing the word. The values of elements of the address, as discussed above, may or may not be the same as the values of the elements of the word, depending on whether an auto- or hetero-associative memory address scheme is being used. An address being used to write or read an SDM word may be stored, for example, in an address register. An address matrix may be stored that includes a set of address vectors as rows of the address matrix. A distance may be calculated as the distance value between the address stored in the address register and each address on each row of the address matrix, and the set of distances may be stored resulting in a set of distances corresponding to each row of the address matrix. The distance may be, for example, a Euclidean distance (e.g., the distance between two points in a Euclidean space), a Manhattan distance (e.g., the sum of the absolute differences of Cartesian coordinates of two points), or any other suitable distance metric representing a relationship between two vectors.

In one or more examples, an address activation value may be selected to be compared with each of the set of calculated distances. The activation value may be selected based on a variety of factors, including, but not limited to, the size of the contents matrix and address matrix, how may vector words will be stored, how large the registers are for storing the input vector word and/or address vector, and a desired tolerance for error when reading values from the contents matrix. In general, larger selected address activation values may result in more errors, but it may be possible to store more information in a contents matrix within the error range.

In one or more examples, the address activation value is compared with each distance corresponding to the rows of the address matrix with which the address value from the address register was used to calculate a distance, and each such row having a distance less than or equal to the selected address activation value may be considered an activated address. As an example, a sense amplifier component may be configured to perform the comparisons, and store a one for each activated address row, and a zero for each non-activated address row. In one or more examples, the activated address rows correspond to rows of the context matrix that will be updated based on the value of the SDM word to be written or read that corresponds to the address that was stored in the address register.

In one or more examples, the contents matrix will include a number of rows, and each row will include an even column (e.g., 0, 2, 4, 6 . . . ) for storing real parts of each element of the input word (e.g., a vector having n elements) and an odd column (e.g., 1, 3, 5, 7 . . . ) for storing the corresponding imaginary part of an element of the input SDM word. Thus, for a vector having n elements that is a SDM word to be stored in the contents matrix, the contents matrix will include 2*n columns (e.g., the contents matrix will have a width of 2*n), with one even column and one odd column corresponding to each of the n elements of the SDM word.

In one or more examples, the contents matrix is initialized to zero at all locations, and each act of writing an input SDM word (e.g., a vector having n elements, each being one of r possible values) will cause an update of the column pairs in each contents matrix row corresponding to an activated address row from the address matrix. In one or more examples, the updating includes, for the real part and imaginary part of each element of the SDM word, adding the values of the real part and the imaginary part to the values already stored in the even and odd numbered columns corresponding to the element at each contents matrix row corresponding to an activated address row.

In one or more examples, to read a word from the contents matrix, the address corresponding to the SDM word is again used, as discussed above, to identify the active rows of the address matrix, which, in turn, identifies a number of corresponding rows of the contents matrix. In one or more examples, the identified activated rows in the contents matrix are then used to generate an accumulated word vector, where the values of each column in the set of identified activated rows of the contents matrix are summed together. In one or more examples, each pair of even and odd columns (which may be referred to as a contents matrix column pair) of the accumulated word are then used as input to an equation for calculating an angle, which is:

$$Round ( \frac{r θ ( γ )}{2 π} )$$

In the above equation, γ is a number having a real and an imaginary part. The real part of a γ value may be obtained from an even numbered column of a column pair of the accumulated word, and the imaginary part of the γ value may be obtained from a corresponding odd numbered column of a column pair of the accumulated word. The real and imaginary part of a number γ may be used to find a value T, which is the inverse tangent of the imaginary part of γ divided by the real part of γ (e.g., T=tan⁻¹ [(Im γ)/(Re γ)]). The real part of γ is obtained from an even numbered column location of the accumulated word vector for a given element to be read, and the imaginary part may be obtained from the odd numbered column corresponding to the even numbered column (e.g., for reading the first element, column zero is the real part and column 1 is the imaginary part of a complex number corresponding to the first element).

θ(γ) in the above equation is equal to T if the real part of γ is greater than or equal to zero and the imaginary part of γ is greater than or equal to zero. θ(γ) is equal to T+2π if the real part of γ is greater than or equal to zero and the imaginary part of γ is less than zero. θ(γ) is equal to T+π if the real part of γ is less than zero. θ(γ) is multiplied by r (the number of possible integer values in a stored word), and the result is divided by 2*π. The result of the division is then rounded to the nearest whole integer, which is the value that is read for the element of the word that was stored at the address.

In one or more examples, the above-techniques for writing and reading information to implement SDM using complex values (e.g., CV-SDM) may be implemented using any suitable hardware capable of implementing registers, storing matrices, performing distance calculations, comparing and storing the results of comparisons between an address activation value and a set of calculated distances, summing the elements of a set of rows (e.g., activated rows from a contents matrix), and performing the aforementioned angle calculation. As an example, an analog content addressable memory (ACAM) component may be used to store the address matrix, and to calculate distances between an address stored in an address register and rows of the address matrix; a sense amplifier may be configured to perform a comparison between the distances and an address activation value, and store the results to indicate row activations; a dot product engine may be used to store and update the contents matrix into which words are written and from which words are read, as well as generate sums of values in columns of activated rows of the contents matrix (e.g., for reading words from the contents matrix), and circuitry may be configured for performing the above-described angle calculation for reading an SDM word from the contents matrix.

Certain examples in this disclosure may provide techniques for implementing SDM that use complex values for representation of integer elements of vectors for writing vectors to and reading vectors from a contents matrix based on activated rows of the contents matrix as determined from activated rows of an address matrix corresponding to the contents matrix. Such techniques may reduce the amount of hardware (e.g., storage components) needed from a value of r*n for storing each vector having n elements of r possible values to only needing 2*n storage components for storing each vector having n elements of r possible values.

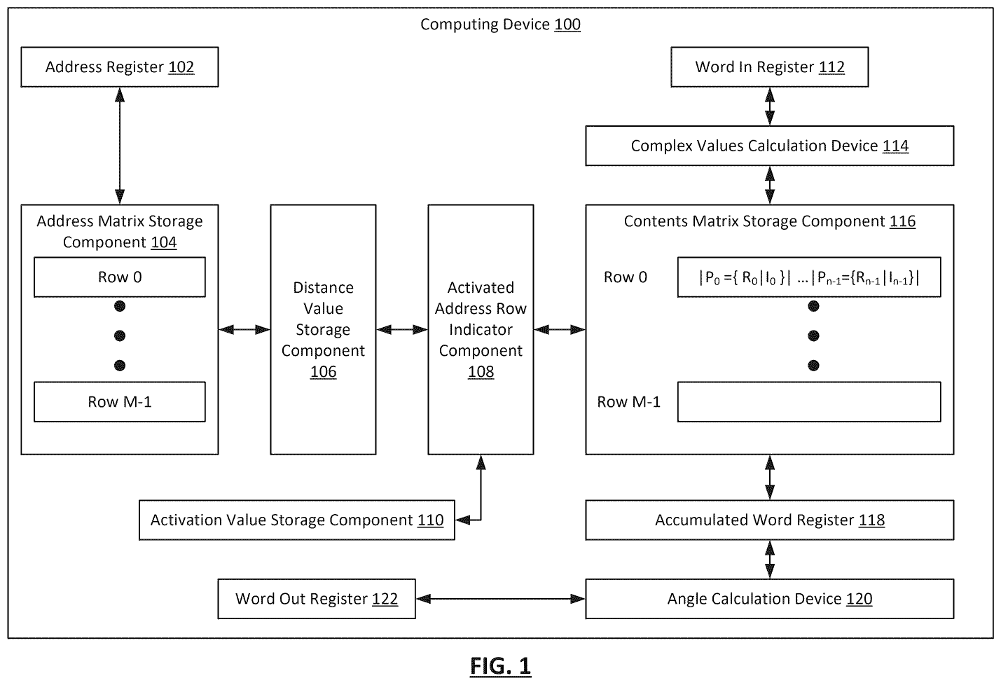

FIG. 1 illustrates a block diagram of an example system for implementing CV-SDM techniques in accordance with one or more examples disclosed herein. As shown in FIG. 1, the system includes a computing device 100. The computing device 100 may include an address register 102, an address matrix storage component 104, a distance value storage component 106, an activated address row indicator component 108, an activation value storage component 110, a word in register 112, a complex values calculation device 114, a contents matrix storage component 116, an accumulated word register 118, an angle calculation device 120, and a word out register 122. Each of these components is described below.

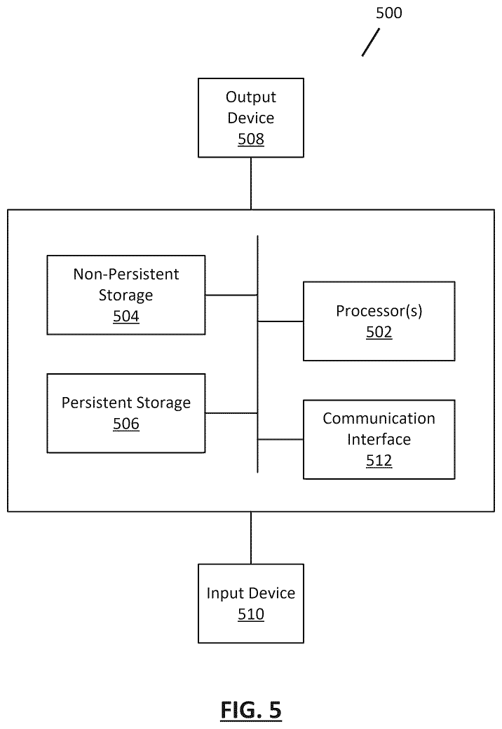

In one or more examples, as used herein, a computing device (e.g., the computing device 100), as used herein, may refer to any single computing device, a set of computing devices, a portion of one or more computing devices, or any other physical, virtual, and/or logical grouping of computing resources. One example of a computing device is shown in FIG. 5, and described below.

Examples of computing devices include, but are not limited to, a server (e.g., a blade-server in a blade-server chassis, a rack server in a rack, a desktop server, any other type of server device), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (ISCSI) storage device, a tape storage device, a flash storage array, a network attached storage device, any other type of storage device), a network device (e.g., switch, router, multi-layer switch, any other type of network device), a virtual machine, a virtualized computing environment, a logical container (e.g., for one or more applications), a container pod, an Internet of Things (IoT) device, an array of nodes of computing resources, a supercomputing device, a data center or any portion thereof, and/or any other type of computing device. As one of ordinary skill in the art will appreciate, any of the aforementioned examples of computing devices necessarily require at least some hardware components. As an example, a virtual machine, a container, and/or a container pod, when considered as a computing device, include the underlying hardware on which the virtual machine, a container, and/or a container pod executes.

In one or more examples, any or all of the aforementioned examples may be combined to create a system of such devices, or may be partitioned into separate logical devices, which may collectively be referred to as a computing device. Other types of computing devices may be used without departing from the scope of examples described herein, such as, for example, the computing device shown in FIG. 5 and described below. The system may include any number and/or type of such computing devices in any arrangement and/or configuration without departing from the scope of examples disclosed herein.

In one or more examples, the storage and/or memory of a computing device (e.g., the computing device 100) or system of computing devices may be and/or include one or more data repositories for storing any number of data structures storing any amount of data (e.g., information). In one or more examples, a data repository is any type of storage unit and/or device (e.g., a file system, database, collection of tables, RAM, hard disk drive, solid state drive, and/or any other storage mechanism or medium) for storing data. Further, a computing device (e.g., 100) may include multiple different storage units and/or devices. The multiple different storage units and/or devices may or may not be of the same type or located at the same physical location. In one or more examples, any storage and/or memory device of the computing device 100 for storing information of any type may be referred to as a storage component. Examples of storage components include, but are not limited to, registers, random access memory (RAM) (e.g., static RAM, (SRAM), dynamic RAM (DRAM), resistive RAM (ReRAM), memristor-based RAM (MRAM), and the like), flash memory, hard disks/drives, content addressable memory (CAM) components (e.g., ternary CAM (TCAM), analog CAM (ACAM)), crosspoint arrays, and any other hardware-based component capable of at least temporarily storing data.

In one or more examples, any storage and/or memory of a computing device or system of computing devices, and/or network devices, whether or not shown in FIG. 1, may be considered, in whole or in part, as non-transitory computer readable mediums, which may store software and/or firmware, which, when executed by one or more processors, cause the one or more processors to perform operations in accordance with one or more examples disclosed herein.

In one or more examples, the computing device 100 includes the address register 102. In one or more examples, the address register 102 is a storage component for storing, at least temporarily, an address corresponding to an SDM word. In one or more examples, an SDM word is a vector representation of data that includes n elements. In one or more examples, each element of the n elements of an SDM word may have a value k, and each element k may have an integer value that is any integer or r possible integer values. An SDM word may include any number n of elements k to represent information, such as, for example, features of a state of a system, physical attributes of a real-world object or scenario, and the like.

In one or more examples, to write an SDM word and/or to read an SDM word using techniques disclosed herein, each SDM word is associated with a corresponding address. In one or more examples the address is a vector that includes some number of elements. The address may be the same as the SDM word (e.g., in an auto-associative memory address scheme), or may be different from the SDM word (e.g., as in a hetero-associative address scheme). In one or more examples, the address register 102 is configured to store an address corresponding to an SDM word when the SDM word is to be written to and/or read from a contents matrix. In one or more examples, the address register is configured to include any number of storage locations for storing elements of an address, each of which may be any value (e.g., integer values) without departing from the scope of examples disclosed herein.

In one or more examples, the address register 102 is operatively connected to the address matrix storage component 104 (discussed further below). Although FIG. 1 shows the computing device 100 as including one address register 102, the computing device 100 may include any number of address registers without departing from the scope of examples disclosed herein.

In one or more examples, the computing device 100 includes the address matrix storage component 104. In one or more examples, the address matrix storage component 104 is any storage component configured to store an address matrix for implementing CV-SDM techniques disclosed herein. In one or more examples, an address matrix is a set of address, organized as rows of a matrix, that represent a high-dimensional virtual space. In one or more examples, an address matrix includes a discrete number of locations, which may be referred to as hard locations, within an address space for SDM. In one or more examples, SDM techniques have address patterns that span a large address space (e.g., 2″ addresses). In one or more examples, it may be impractical for each possible address in such an address space to have a corresponding physical location in hardware. Accordingly, in one or more examples, the address matrix stored in the address matrix storage component 104 includes a smaller number of hard locations addressed using addresses represented in the address matrix.

In one or more examples, the addresses stored in the address matrix in the address matrix storage component 104 are a distributed (e.g., evenly, uniformly, and/or randomly distributed) subset of addresses that span the address space of the SDM technique being used. Thus, each row of the address matrix may be a separate address in the SDM address space.

The address matrix storage component 104 may store an address matrix that includes any number of rows (e.g., the row 0 to row M-1 shown in FIG. 1). In some examples, the address matrix storage component 104 is implemented using an ACAM. In one or more examples, the cells of the ACAM may be used to store the elements of the address matrix. As an example, an ACAM may be configured as a set of rows and columns, with each row-column cell storing a value or range of values as voltages that represent elements of the addresses of the address matrix. In one or more examples, each storage location for an element of an address matrix in the address matrix storage component 104 may be any value (e.g., an analog value stored in an ACAM), and thus may, in some examples, be integer values.

In one or more examples, the computing device 100 includes the distance value storage component 106. In one or more examples, the distance value storage component 106 is any storage component configured to store distance values that are calculated based on an address in the address register 102 and the address matrix. In one or more examples, a distance value is a value that represents a similarity between an address (e.g., stored in the address register 102) and an address of a row of an address matrix stored in the address matrix storage component 104. In one or more examples, any suitable distance metric as a distance value without departing from the scope of examples disclosed herein.

In one or more examples, when an SDM word is to be written to and/or read from a contents matrix (e.g., stored in the contents matrix storage component 116, discussed below), each row of an address matrix stored in the address matrix storage component 104, and an address in the address register, are used to calculate a set of distance values, each corresponding to a separate row of the address matrix.

As an example, a Euclidean distance may be calculated as the distance value for the address and a row of the address matrix. In one or more examples, the Euclidean distance may be calculated by determining the difference between each element in the address and corresponding elements of the row of the address matrix, squaring the differences, summing the squared differences, and then taking the square root of the summed squared differences. Other distance metrics may be used as distance values without departing from the scope of examples disclosed herein (e.g., Manhattan distances, Hamming distances, and the like).

In one or more examples, a distance value corresponding to each row of an address matrix stored in the address matrix storage component 104 is stored in the distance value storage component 106. In one or more examples, although FIG. 1 shows the address matrix storage component 104 and the distance value storage component 106 as separate components, the address matrix storage component 104 and the distance value storage component 106 may be part of the same component. As an example, the address matrix storage component 104 and the distance value storage component 106 may be implemented as part of an ACAM configured to calculate the distance values for each row of the address matrix. In such an example, the address stored in the address register 102 may be used as an input to an ACAM storing an address matrix, and the cells of the ACAM may be configured, per row, to perform the above-described calculation for Euclidean distance. In one or more examples, a distance value stored in the distance value storage component 106 may be any value (e.g., 10, 235, 456, 794, 1037, and the like). As such, the distance value storage component 106 may include storage locations corresponding to each row of an address matrix that are configured to store such values.

In one or more examples, the computing device 100 includes the activated address row indicator component 108. In one or more examples, the activated address row indicator component 108 is a component that is configured to perform a comparison between distance values stored in the distance value storage component 106 and an activation value stored in the activation value storage component 110. In one or more examples, the activation value may be selected based on a variety of factors, including, but not limited to, the size of the contents matrix and address matrix, how many vector words will be stored, how large the registers are for storing the input vector word and/or address vector, and a desired tolerance for error when reading values from the contents matrix. In general, larger selected address activation values may result in more errors, but it may be possible to store more information in a contents matrix within the error range. In one or more examples, the activation value is stored in the activation value storage component 110, which may be any type of storage component (e.g., a register).

In one or more examples, the activated address row indicator component 108 is configured to compare a distance value corresponding to each row of the address matrix stored in the distance value storage component 106 with the activation value stored in the activation value storage component 110 to determine whether the activation value is less than or equal to the activation value. In one or more examples, when a distance value is less than or equal to the activation value, a one is stored in a location in the activated address row indicator component 108 corresponding to the address row that yielded the distance value; otherwise a zero is stored. Thus, the activated address row indicator component 108 is configured to perform the aforementioned comparison to generate values corresponding to address rows for which a distance value is less than or equal to the activation value, which indicates a set of activated address rows. In one or more examples, the set of activated address rows are address rows that are sufficiently similar to the address stored in the address register 102 based on the distance value obtained using the address and a row of the address matrix stored in the address matrix storage component 104. In one or more examples, each address row of the set of activated address rows as indicated by the activated address row indicator component 108 corresponds to a row of the contents matrix stored in the contents matrix storage component 116 (discussed below).

In one or more examples, the computing device 112 includes the word in register 112. In one or more examples, the word in register is any storage component that is configured to store an SDM word that is to be written to a contents matrix stored in the contents matrix storage component 116. As discussed above, an SDM word may be a vector representation of data of any type that includes n elements k, where k may be any integer value from a set of r possible integers (e.g., when r=5, k may be 0, 1, 2, 3, or 4). An SDM word may include any number of elements (e.g., an SDM word may include any number n of elements therein). In one or more examples, when an SDM word is to be written to a contents matrix, the SDM word is stored in the word in register 112. As such, the word in register 112 may be a storage component configured to store a quantity n of integer values k of the SDM word. The integer values may be stored using any suitable technique for storing integer values (e.g., multibit storage elements, counters, and the like).

In one or more examples, the computing device 100 includes the complex values calculation device 114. In one or more examples, the complex values calculation device 114 is any hardware (e.g., circuitry), or any combination of software and/or firmware with such hardware, that is configured to calculate complex values for each element of a SDM word stored in the word in register 112. In one or more examples, each element k of a SDM word in the word in register 112 may be represented as a complex number φ(k) having a real part, calculated by the cosine of (2*π*k) divided by r, and an imaginary part, calculated by the imaginary unit i multiplied by the sine of (2*π*k) divided by r, which may also be shows as:

$$φ ( k ) = cos ( \frac{2 π k}{r} ) + i sin ( \frac{2 π k}{r} )$$

In one or more examples, the complex values calculation device 114 is configured to calculate a real part and an imaginary part φ(k) for each value k of the n values of the SDM word in the word in register 112 based on the above equation.

In one or more examples, the computing device 100 includes the contents matrix storage component 116. In one or more examples, the contents matrix storage component is any storage component configured to store a contents matrix. In one or more examples, a contents matrix is a matrix of values for storing information when implementing SDM techniques. In one or more examples, a contents matrix may be initialized to include zeros for each element therein. In one or more examples, the contents matrix may be updated as SDM words are stored into the contents matrix from the word in register 112. As such, the contents matrix storage component 116 may include storage elements for each location in a matrix. In one or more examples, the contents matrix may have a number of rows that is equivalent to the number of rows of the address matrix discussed above. In one or more examples, each location in the contents matrix storage component is configured to store a real part (e.g., in even numbered columns) or an imaginary part (e.g., in odd numbered columns) of numbers corresponding to elements of SDM words. As such, in one or more examples, each storage location of the contents matrix storage component storing values of a contents matrix may be configured to store any numerical value, including representations of integers, whole numbers, fractional numbers, rational numbers, irrational numbers, and the like. As an example, the contents matrix storage component may include a crosspoint array of memristors or programmable resistors whose conductance or resistance values represent the value of an element of a contents matrix, and that may be updated over time as new SDM words are written to the contents matrix.

In one or more examples, the contents matrix has a number of columns that is two times the number of elements n of SDM words to be stored in the contents matrix. In one or more examples, each element position of an SDM word corresponds to a contents matrix column pair of the contents matrix. In one or more examples, each contents matrix column pair includes an even numbered column for storing real parts of complex numbers and a corresponding odd numbered column for storing imaginary parts of complex numbers. As an example, the first element in a SDM word may correspond to a contents matrix column pair that includes column 0 for storing a real part of a complex values representation of an integer element, and a column 1 for storing the imaginary part of the complex values representation of an integer element. FIG. 1 shows such structure in the representation of Row 0 in which each position (e.g., P₀, Pₙ₋₁) corresponds to a real and imaginary part pair (e.g., R₀|I₀, Rₙ₋₁|Iₙ₋₁).

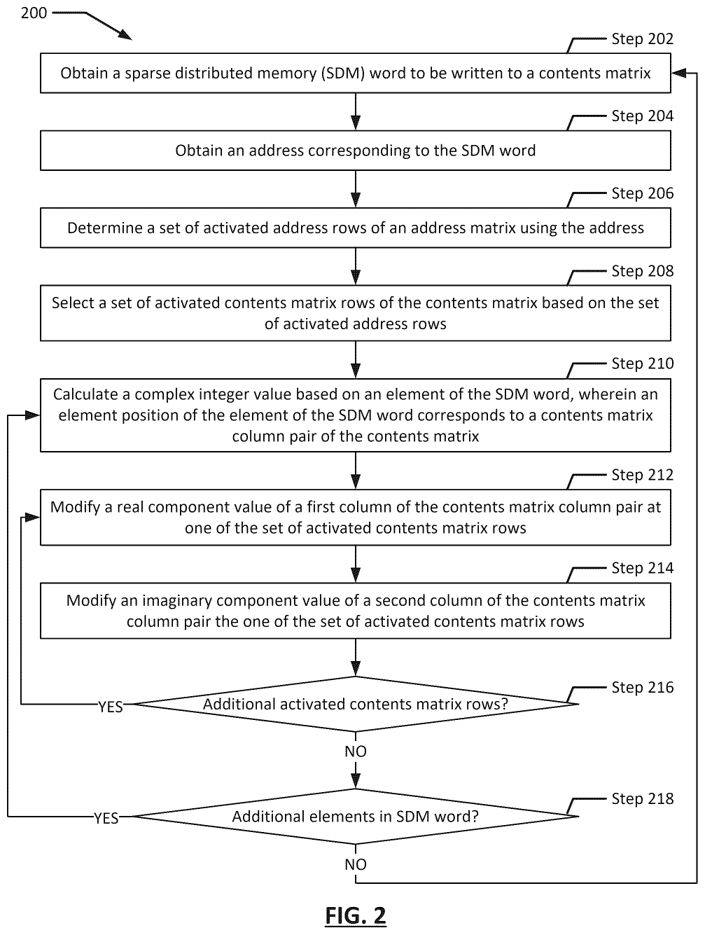

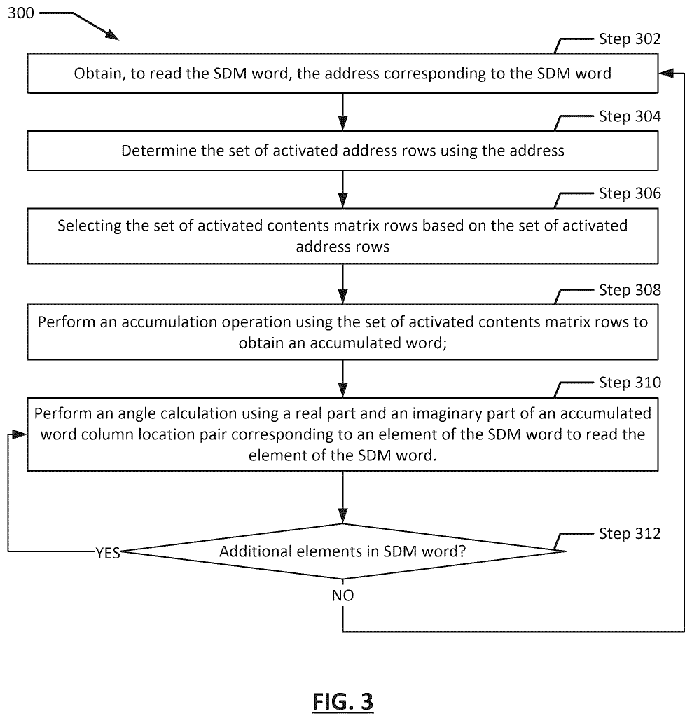

In one or more examples, each row in the contents matrix stored in the contents matrix storage component 116 corresponds to a row of the address matrix stored in the address matrix storage component 104, and, thus, to a row of the activated address row indicator component 108. In one or more examples, when a one is stored in the activated address row indicator component 108, the one indicates that the row of the contents matrix to which it corresponds is part of a set of activated contents matrix rows. In one or more examples, when a SDM word is to be written to or read from the contents matrix, the set of activated contents matrix rows are used to perform the read or write. Writing to and reading from the contents matrix are discussed further in the descriptions of FIG. 2 and FIG. 3, below.

In one or more examples, although the complex values calculation device 114 and the contents matrix storage component 116 are shown in FIG. 1 as separate components, the complex values calculation device 114 and the contents matrix storage component 116 may be part of the same component. As an example, the complex values calculation device 114 and the contents matrix storage component 116 may each be part of a crosspoint array used to implement a dot product engine that is configured to perform various operations, such as the arithmetic operations used to calculate the complex values representation of integers of a SDM word from the word in register 112. In one or more examples, the crosspoint array may be initialized to include an array of zeros as the contents matrix, and each write of an SDM word to the contents matrix may cause an update to the set of activated contents matrix rows corresponding to the address associated with the SDM word to be written. Alternatively, the complex values calculation device 114 may be implemented using a general-purpose CPU separate from the contents matrix storage component 116.

As an example, when the initial contents matrix includes all zeros, the real part and imaginary part of a complex number corresponding to an element of a SDM word to be written may be added to the corresponding contents matrix column pair locations for each of the set of activated contents matrix rows of the contents matrix stored in the contents matrix storage component. For each subsequent write of an SDM word, the values of the storage components of the set of activated contents matrix rows for that SDM word may be updated to add the real an imaginary part values of each element of the SDM word to the contents already stored in the contents matrix column pair locations.

For example, when a first SDM word is written to the contents matrix, and a real part of a complex value's representation of the integer of a first element of the SDM word is two, the two may be added to the zero of the initial contents matrix at the even numbered column location (e.g., the location of column zero) for each of the rows of the set of activated contents matrix rows for the SDM word. When a subsequent SDM word is to be written, and one of the rows of the previously written-to set of rows is included in the set of activated contents matrix rows, the real part of a complex values representation of an integer of a first element of the subsequent SDM word may be added to the two that is present in the location from the previous write. Thus, in one or more examples, the contents matrix is updated over time as SDM words are written to the contents matrix to sets of activated contents matrix rows.

In one or more examples, the computing device 100 includes the accumulated word register 118. In one or more examples, the accumulated word register 118 is a storage component of any type that is configured to store an accumulated word. In one or more examples, an accumulated word is a set of values accumulated from a set of contents matrix rows when performing a read from a contents matrix stored in the contents matrix storage component 116.

As an example, when a SDM word is to be read from the contents matrix, the address corresponding to the SDM word is used, as discussed above, to identify a set of activated address rows. The set of activated address rows are used to identify a set of activated contents matrix rows. The values in each column of the set of activated contents matrix rows are summed to determine a value for each column location in the accumulated word register 118.

In one or more examples, each even column location in the accumulated word register 118 corresponds to a real part of a number, and an adjacent odd numbered column location in the accumulated word register 118 corresponds to an imaginary part of the same number. In one or more examples, each such even-odd column location pair in the accumulated word register corresponds to an element of the SDM word that is being read.

In one or more examples, the computing device 100 includes the angle calculation device 120. In one or more examples, the angle calculation device 120 is any hardware (e.g., circuitry), or software and/or firmware combined with such hardware, that is configured to perform an angle calculation for each even-odd column pair location of an accumulated word stored in the accumulated word register 118. In one or more examples, the angle calculation device is configured to, at least: (i) determine if a real part stored in an even numbered column location, and an imaginary part stored in an odd numbered column location, are less than zero or greater than or equal to zero; (ii) calculate a T value using a real part and an imaginary part of an even-odd column location pair from the accumulated word by calculating the inverse tangent of the imaginary part divided by the real part, and (iii) determine a value of φ(γ) based on the results of (i) and (ii). In one or more examples, φ(γ) is equal to T if the real part of Y is greater than or equal to zero and the imaginary part of γ is greater than or equal to zero; φ(γ) is equal to T+2π if the real part of γ is greater than or equal to zero and the imaginary part of γ is less than zero; and φ(γ) is equal to T+π if the real part of γ is less than zero. In one or more examples, the angle calculation device 120 is also configured to determine elements of a word to be read by multiplying each result φ(γ) by r (the number of possible integer values for the SDM word being read), and dividing the result by 2*π to obtain a value, which is rounded to the nearest whole integer to obtain the value k for an element of the SDM word being read.

In one or more examples, the computing device 100 includes the word out register 122. In one or more examples, the word out register 122 is a storage component of any type for storing the results from the angle calculation device as elements k or a SDM word being read.

While FIG. 1 shows a particular configuration of components, other configurations may be used without departing from the scope of examples described herein. For example, although FIG. 1 shows certain components as part of the same device, any of the components may be grouped in sets of one or more components which may exist and execute as part of any number of separate and operatively connected devices. As another example, a single component may be configured to perform all or any portion of the functionality performed by the components shown in FIG. 1. Accordingly, examples disclosed herein should not be limited to the configuration of components shown in FIG. 1.

FIG. 2 illustrates an overview of an example method 200 for writing a SDM word to a contents matrix in accordance with one or more examples disclosed herein. The method 200 may be performed, at least in part, by a computing device (e.g., the computing device 100 shown in FIG. 1, the computing device 500 shown in FIG. 5), and/or any one or more components included therein (e.g., the address register 102, the address matrix storage component 104, the distance value storage component 106, the activated address row indicator component 108, the activation value storage component 110, the word in register 112, the complex values calculation device 114, the contents matrix storage component 116, the accumulated word register 118, the angle calculation device 120, and/or the word out register 122 shown in FIG. 1).

While the various steps in the flowchart shown in FIG. 2 are presented and described sequentially, some or all of the steps may be executed in different orders, some or all of the steps may be combined or omitted, and some or all of the steps may be executed in parallel with other steps of FIG. 2 and/or FIG. 3 (described below). Accordingly, examples disclosed herein are not limited to the particular set of or order of Steps shown in FIG. 2.

In Step 202, the method 200 includes obtaining a SDM word to be written to a contents matrix. In one or more examples, the SDM word is any set of integer values as elements of a vector that represents information (e.g., features of an object or system, a state of a system, and the like). In one or more examples, the SDM word is stored in a word in register (e.g., the word in register 112 of FIG. 1). The SDM word may be obtained from any source (e.g., sensors, another computing device, another component of a computing device, via a network connection, any other technique for obtaining information).

In Step 204, the method 200 includes obtaining an address corresponding to the SDM word. In one or more examples, each SDM word to be written using the CV-SDM technique disclosed herein has a corresponding address. In one or more examples, the address is a set of values that may be represented as a vector of discrete elements. In some examples, the values of the address are the same as the values of the SDM word to be written. In other examples, the values of the address are different from the values of the SDM word to be written. In one or more examples, the address is stored in an address register (e.g., the address register 102 of FIG. 1).

In Step 206, the method 200 includes determining a set of activated address rows of an address matrix using the address. In one or more examples, an address matrix that includes any number of hard locations distributed within a virtual space for the SDM techniques being implemented is stored in an address matrix storage component (e.g., the address matrix storage component 104 of FIG. 1). In one or more examples, the address obtained in Step 204 is used with each row of the address matrix to calculate a distance value corresponding to each row of the address matrix. As an example, the elements of the address and elements of a row of the address matrix may be used to calculate a Euclidean distance between the address and the row of the address matrix. In one or more examples, each calculated distance value is stored (e.g., in the distance value storage component 106 of FIG. 1).

In one or more examples, the distance values are compared (e.g., by the activated address row indicator component 108 of FIG. 1) with an activation value stored in an activation value storage component (e.g., the activation value storage component 110 of FIG. 1). In one or more examples, if a given distance value is less than or equal to the activation value, then the address row corresponding to the distance value may be considered to be an activated row, which may be represented by a value (e.g., a one) stored in the activated address row indicator component. In one or more examples, the value stored in the activated address row indicator component that indicates an activated address row may be referred to as an activated value, and a value indicating that an address row is not activated may be referred to as a non-activated value. In one or more examples, the set of address rows that are activated as indicated by the activated values are the set of activated address rows.

In Step 208, the method 200 includes selecting a set of activated contents matrix rows based on the set of activated address rows. In one or more examples, each of the address rows of the address matrix correspond to a row of the contents matrix. In one or more examples, the set of activated address rows determined in Step 206 may be used to identify, and thus select, a corresponding set of activated contents matrix rows of the contents matrix, which may be stored, for example, in a contents matrix storage component (e.g., the contents matrix storage component 116 of FIG. 1).

In Step 210, the method 200 includes calculating a complex value based on an element of the SDM word. In one or more examples, an element position of the element of the SDM word corresponds to a contents matrix column pair of the contents matrix. As an example, the first element position of the SDM word may correspond to column zero (e.g., an even numbered column) and column one (e.g., an odd numbered column) of the contents matrix. In one or more examples, calculating the complex value for an element of the SDM word includes calculating a real part to be stored in the even numbered column location of the contents matrix column pair by calculating the cosine of (2*π*k) divided by r, where k is the value of the element of the SDM word and r is the quantity of possible integer values of k. In one or more examples, calculating the complex value for an element of the SDM word also includes calculating an imaginary part to be stored in the odd numbered column location of the contents matrix column pair by calculating the sine of (2*π*k) divided by r.

In Step 212, the method 200 includes modifying a real component value of a first column of the contents matrix column pair at one activated contents matrix row of the set of activated contents matrix rows. In one or more examples, the real part calculated in Step 210 is used to update each row of the set of activated contents matrix rows at the even numbered column location corresponding to the element for which the complex value was calculated in Step 210. In one or more examples, modifying the real component value of a location of the contents matrix includes adding the real part calculated in Step 210 to a value already stored in the location. As an example, if the contents matrix location is zero, then the real part is added to zero. As another example, if the contents matrix location is a non-zero value based on a previous one or more modifications, the real part is added to the non-zero value and the result is stored as the new value for the location.

In Step 214, the method 200 includes modifying an imaginary component value of a second column of the contents matrix column pair at one activated contents matrix row of the set of activated contents matrix rows. In one or more examples, the imaginary part calculated in Step 210 is used to update each row of the set of activated contents matrix rows at the odd numbered column location corresponding to the element for which the complex value was calculated in Step 210. In one or more examples, modifying the imaginary component value of a location of the contents matrix includes adding the imaginary part calculated in Step 210 to a value already stored in the location. As an example, if the contents matrix location is zero, then the imaginary part is added to zero. As another example, if the contents matrix location is a non-zero value based on a previous one or more modifications, the imaginary part is added to the non-zero value and the result is stored as the new value for the location.

In Step 216, the method 200 includes making a determination as to whether there are any additional activated contents matrix rows in the set of activated contents matrix rows. In one or more examples, if there are additional activated contents matrix rows, the method returns to Step 212 to use the real and imaginary parts calculated in Step 210 to modify another activated contents matrix row at an odd-even column pair location corresponding to the element location for which the complex value was calculated. In one or more examples, if there are no more additional activated contents matrix rows in the set of activated contents matrix rows, the method proceeds to Step 218.

In Step 218, the method 200 includes making a determination as to whether there are additional elements in the SDM word obtained in Step 202. In one or more examples, if there are additional elements, the method 200 returns to Step 210 to calculate another complex value for the next element of the SDM word, and use the real and imaginary parts of the complex value to perform Step 212 and Step 214 for each of the activated contents matrix rows in the set of activated contents matrix rows, as described above. In one or more examples, if there are no additional elements in the SDM word, the method returns to Step 202 to obtain another SDM word, if any, that is to be written to the contents matrix.

FIG. 3 illustrates an overview of an example method 300 for reading a SDM word from a contents matrix in accordance with one or more examples disclosed herein. The method 300 may be performed, at least in part, by a computing device (e.g., the computing device 100 shown in FIG. 1, the computing device 500 shown in FIG. 5), and/or any one or more components included therein (e.g., the address register 102, the address matrix storage component 104, the distance value storage component 106, the activated address row indicator component 108, the activation value storage component 110, the word in register 112, the complex values calculation device 114, the contents matrix storage component 116, the accumulated word register 118, the angle calculation device 120, and/or the word out register 122 shown in FIG. 1).

While the various steps in the flowchart shown in FIG. 3 are presented and described sequentially, some or all of the steps may be executed in different orders, some or all of the steps may be combined or omitted, and some or all of the steps may be executed in parallel with other steps of FIG. 3 and/or FIG. 2 (described above). Accordingly, examples disclosed herein are not limited to the particular set of or order of Steps shown in FIG. 3.

In Step 302, the method 300 includes obtaining, to read a SDM word, the address corresponding to the SDM word. In one or more examples, the address is stored in an address register (e.g., the address register 102 of FIG. 1).

In Step 304, the method 300 includes determining the set of activated address rows using the address. In one or more examples, the set of activated address rows may be determined as discussed above in the description of Step 206 of FIG. 2.

In Step 306, the method 300 includes selecting a set of activated contents matrix rows based on the set of activated address rows determined in Step 304. In one or more examples, the set of activated contents matrix rows may be selected in the same manner as discussed in the description above of Step 208 of FIG. 2.

In Step 308, the method 300 includes performing an accumulation operation using the set of activated contents matrix rows to obtain an accumulated word. In one or more examples, the accumulation operation includes summing the values in the columns of the set of activated contents matrix rows selected in Step 306. As an example, for a given column, the values in that column in each of activated contents matrix row of the set of activate contents matrix rows are accumulated (e.g., summed) to obtain an accumulated value, and the accumulated value is stored as part of the accumulated word (e.g., in the accumulated word register) at the appropriate location for the column that is summed. In one or more examples, each column of the set of active contents matrix rows is summed to obtain each corresponding value of the accumulated word. As an example, if a set of activated contents matrix rows includes three rows, and the values of column twenty-seven of those rows are—2, 6, and 3, then the value in the location of the column in the accumulated word is 7.

In Step 310, the method 300 includes performing an angle calculation using a real part and an imaginary part of an accumulated word column location pair corresponding to an element of the SDM word to read the element of the SDM word. In one or more examples, each contents matrix column location pair (e.g., column zero and one, column two and three) corresponds to a pair of adjacent value locations in the accumulated word. For each such pair, the even numbered column location corresponds to a real part and the odd numbered column location corresponds to an imaginary part of a complex number γ. In one or more examples, the imaginary part is divided by the real part, and the inverse tangent is calculated for the result of the division to obtain a value T. In one or more examples, the value T Is used to determine θ(γ), the angle corresponding to the value γ. θ(γ) is equal to T if the real part of γ is greater than or equal to zero and the imaginary part of γ is greater than or equal to zero. θ(γ) is equal to T+2π if the real part of γ is greater than or equal to zero and the imaginary part of γ is less than zero. θ(γ) is equal to T+π if the real part of γ is less than zero. In one or more examples, θ(γ) is multiplied by r (the number of possible integer values of an element k in a SDM word), and the result is divided by 2*π. The result of the division is then rounded to the nearest whole integer, which is the value that is read for the element of the SDM word that was stored at the address.

In Step 312, the method 300 includes making a determination as to whether there are additional elements in the SDM word. In one or more examples, if there are additional elements to be read, the method 300 returns to Step 310 to perform an angle calculation for the element using the even-odd columns pair location corresponding to the element. In one or more examples, if there are no additional elements, the method returns to Step 302.

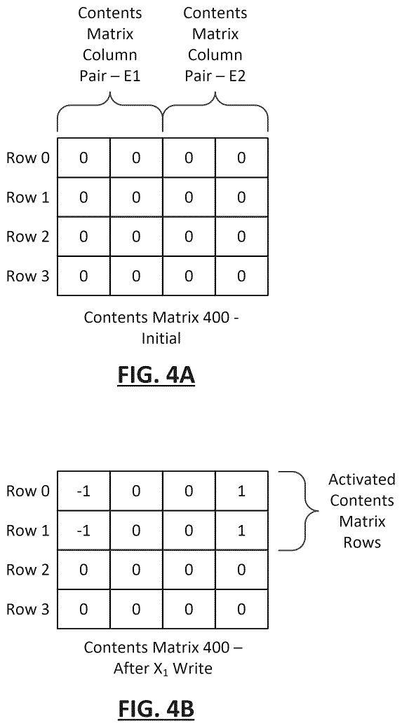

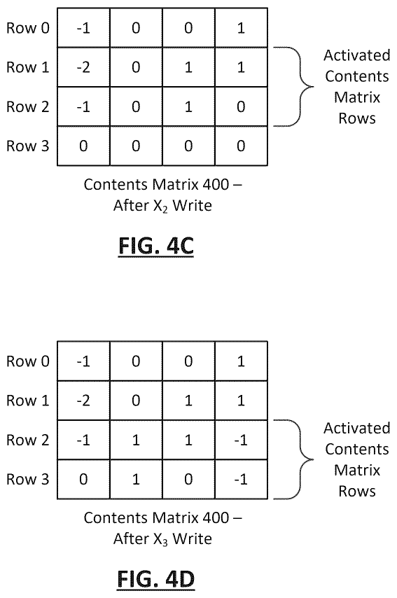

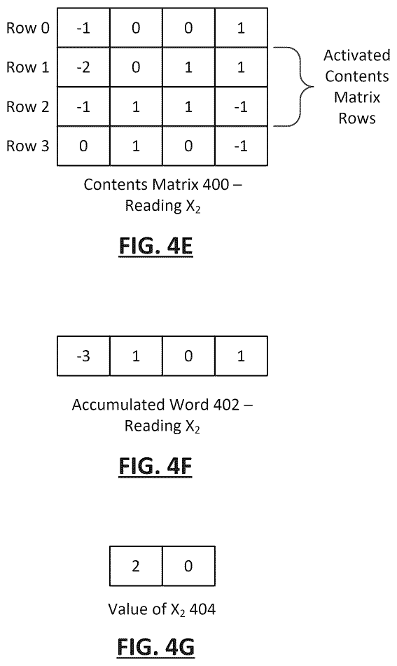

FIGS. 4A-4G illustrate an example of writing SDM words to a contents matrix, and then reading one of the SDM words from the contents matrix, in accordance with one or more examples disclosed herein. The example shown in FIGS. 4A-4G and discussed below is a highly simplified example intended for explanatory purposes only, and not intended to limit the scope of examples described herein. One of ordinary skill in the art, having the benefit of this disclosure, will appreciate that such a scenario may include a much larger SDM word, a much larger contents matrix, than what is used for the simple example of FIGS. 4A-4G. Additionally, while the example shows certain aspects of examples disclosed herein, all possible aspects of such examples may not be illustrated in this particular example.

Consider a scenario where a CV-SDM technique, as described herein, is used to write and read SDM words to and from a contents matrix. In such a scenario, the SDM words to be written have two elements (e.g., n=2), and each element is one of four possible integer values, 0, 1, 2, or 3 (e.g., r=4).

A four-row contents matrix to which the SDM words are to be written is initialized to include all zeros, as shown in FIG. 4A as an initial contents matrix 400. Because the SDM words each have two elements, the width of the contents matrix is 2*n, e.g., four columns. The first contents matrix column pair is shown in FIG. 4A as E1, and corresponds to the first element of the SDM words. The second contents matrix column pair is shown in FIG. 4A as E2, and corresponds to the second element of the SDM words.

The first SDM word to be written is X1, and is [2, 1]. To write X1, the values of X1 are written to a word in register (not shown), and an address corresponding to X1 is used to determine that the activated address rows and corresponding activated contents matrix rows for X1 are row 0 and row 1 as labeled in FIG. 4A. For the first element, 2, of X1, a real part of −1 and an imaginary part of 0 are calculated, and stored, respectively in the first column pair E1 of row 0 and row 1 of the contents matrix 400, as shown in FIG. 4B. For the second element, 1, of X1, a real part of 0 and an imaginary part of 1 are calculated, and stored, respectively in the second column pair E2 of row 0 and row 1 of the contents matrix 400, as shown in FIG. 4B.

The second SDM word to be written is X2, and is [2, 0]. To write X2, the values of X2 are written to a word in register (not shown), and an address corresponding to X2 is used to determine that the activated address rows and corresponding activated contents matrix rows for X2 are row 1 and row 2 as labeled in FIG. 4B. For the first element, 2, of X2, a real part of −1 and an imaginary part of 0 are calculated, and used to update the even column of the first column pair E1 of row 1 and row 2, as shown in FIG. 4C. As shown in FIG. 4C, the real part calculated for the first element of X2 is added to the contents shown in FIG. 4B, such that row 1 becomes −2 (which is −1+−1), and row 2 becomes −1 (which is −1+0). Similarly, the imaginary part of the first element of X2, 0, is added to the contents of the second column of column pair E1. For the second element, 0, of X2, a real part of 1 and an imaginary part of 0 are calculated, and added to the column pair E2 for row 1 and row 2. At this point, the contents matrix is as shown in FIG. 4C after the write of X1 and X2 to the contents matrix 400. To write X3, the values of X3 are written to a word in register (not shown), and an address corresponding to X3 is used to determine that the activated address rows and corresponding activated contents matrix rows for X3 are row 2 and row 3 as labeled in FIG. 4C. The real part of the first element of X3, 1, is 0 and the imaginary part is 1. The real part of the second element of X3, 3, is 0 and the imaginary part is −1. The real and imaginary parts of the first and second element of X3 are thus used to update the activated contents matrix rows 2 and 3, with the results as shown in FIG. 4D. At this point, the contents matrix is as shown in FIG. 4D after the write of X1, X2, and X3 to the contents matrix 400.

Next, the X2 is to be read from the contents matrix 400 as shown in FIG. 4D. To read X2, the address corresponding to X2 is again used to determine that row 1 and row 2 are the set of activated contents matrix rows, as shown in FIG. 4E. Thus, the values of each column in row 1 and row 2 are summed to obtain an accumulated word 402, as shown in FIG. 4F. Thus, the first element of X2 corresponds to the values −3 (the real part) and 1 (the imaginary part) in the column pair location E1 of the accumulated word 402, and the second element of X2 corresponds to the values 0 (the real part) and 1 (the imaginary part) in the column pair location E2 of the accumulated word 402. These real and imaginary parts are used by an angle calculation device to determine the values of the elements of X2 to be [2, 0], which is what was previously written for X2. Thus, X2 is successfully read from the contents matrix.

FIG. 5 illustrates a block diagram of a computing device, in accordance with one or more examples of this disclosure. As discussed above, examples described herein may be implemented using computing devices, and the computing device 500 shown in FIG. 5 may be such a computing device. For example, all or any portion of the components shown in FIG. 1 (e.g., the address register 102, the address matrix storage component 104, the difference value storage component 106, the activated address row indicator component 108, the activation value storage component 110, the word in register 112, the complex values calculation device 114, the contents matrix storage component 116, the accumulated word register 118, the angle calculation device 120, and/or the word out register 122) may be implemented, at least in part using the computing device 500, and may include all or any portion of the components of the computing device 500 shown in FIG. 5 and described below. Additionally, all or any portion of the method shown in FIG. 2 and/or FIG. 3 may be performed using one or more computing devices, such as the computing device 500.

In one or more examples, a computing device (e.g., the computing device 500) is any device, portion of a device, or any set of devices capable of electronically processing instructions and may include, but is not limited to, any of the following: one or more processors (e.g. components that include circuitry) (e.g., the processor 502), memory (e.g., random access memory (RAM)) (not shown), input and output device(s) (e.g., the non-persistent storage 506), non-volatile storage hardware (e.g., solid-state drives (SSDs), persistent memory (Pmem) devices, hard disk drives (HDDs) (not shown)), one or more physical interfaces (e.g., network ports, storage ports) (e.g., the persistent storage 506), any number of other hardware components (not shown), and/or any combination thereof. As used herein, a processor may be any component that can be configured to execute operations, processes, threads, and the like. Examples of a processor include, but are not limited to, central processing units (CPUs), multi-core CPUs, application-specific integrated circuits (ASICs), accelerators (e.g., graphics processing units (GPUs)), and field programmable gate arrays (FPGAs). Other examples of processor types may be included in the computing device 500 without departing from the scope of examples disclosed herein. In some examples, a computing device (e.g., the computing device 500) may include any number of heterogeneous processors (e.g., the heterogeneous processors 114 of FIG. 1).

The computing device 500 may include a communication interface 512 (e.g., Bluetooth interface, infrared interface, network interface, optical interface, any other type of communication interface), input devices 510, output devices 508, and numerous other elements (not shown) and functionalities. Each of these components is described below.

In one or more examples, the computer processor(s) 502 may be an integrated circuit for processing instructions. For example, the computer processor(s) may be one or more cores or micro-cores of a processor. The processor 502 may be a general-purpose processor configured to execute program code included in software executing on the computing device 500. The processor 502 may be a special purpose processor where certain instructions are incorporated into the processor design. The processor 502 may be an application specific integrated circuit (ASIC), a graphics processing unit (GPU), a data processing unit (DPU), a tensor processing units (TPU), an associative processing unit (APU), a vision processing units (VPU), a quantum processing units (QPU), and/or various other processing units that use special purpose hardware (e.g., field programmable gate arrays (FPGAs), System-on-a-Chips (SOCs), digital signal processors (DSPs)). Although only one processor 502 is shown in FIG. 5, the computing device 500 may include any number of processors without departing from the scope of examples disclosed herein.

The computing device 500 may also include one or more input devices 510, such as a touchscreen, keyboard, mouse, microphone, touchpad, electronic pen, motion sensor, or any other type of input device. The input devices 510 may allow a user to interact with the computing device 500. In one or more examples, the computing device 500 may include one or more output devices 508, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 502, non-persistent storage 504, and persistent storage 506. Many different types of computing devices exist, and the aforementioned input and output device(s) may take other forms. In some instances, multimodal systems can allow a user to provide multiple types of input/output to communicate with the computing device 500.

Further, the communication interface 512 may facilitate connecting the computing device 500 to a network (not shown) (e.g., a local area network (LAN), a wide area network (WAN) such as the Internet, mobile network, or any other type of network) and/or to another device, such as another computing device. The communication interface 512 may perform or facilitate receipt and/or transmission of wired or wireless communications using wired and/or wireless transceivers of any type and/or technology. Examples include, but are not limited to, those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 512 may also include one or more Global Navigation Satellite System (GNSS) receivers or transceivers that are used to determine a location of the computing device 500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, and the like may be passed, forwarded, or transmitted via any suitable means including memory sharing, message passing, token passing, network transmission, or the like.

All or any portion of the components of the computing device 500 may be implemented in circuitry. For example, the components can include and/or can be implemented using electronic circuits or other electronic hardware, which can include one or more programmable electronic circuits (e.g., microprocessors, GPUs, DSPs, FPGAs, CPUs, CAMs, and/or other suitable electronic circuits), and/or can include and/or be implemented using computer software, firmware, or any combination thereof, to perform the various operations described herein. In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In the above description, numerous details are set forth as examples described herein. It will be understood by those skilled in the art (who also have the benefit of this disclosure) that one or more examples described herein may be practiced without these specific details, and that numerous variations or modifications may be possible without departing from the scope of the examples described herein. Certain details known to those of ordinary skill in the art may be omitted to avoid obscuring the description.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including functional blocks that may include devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects of examples disclosed herein.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not included in a drawing. A process may correspond to a method, a function, a procedure, a subroutine, a subprogram, and the like. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, and the like. Examples of computer-readable media that may be used to store instructions, information used, and/or information created during methods according to described examples include magnetic or optical disks, flash memory, USB devices provided with non-volatile memory, networked storage devices, and so on.

In the above description of the figures, any component described with regard to a figure, in various examples described herein, may be equivalent to one or more same or similarly named and/or numbered components described with regard to any other figure. For brevity, descriptions of these components may not be repeated with regard to each figure. Thus, each and every example of the components of each figure is incorporated by reference and assumed to be optionally present within every other figure having one or more same or similarly named and/or numbered components. Additionally, in accordance with various examples described herein, any description of the components of a figure is to be interpreted as an optional example, which may be implemented in addition to, in conjunction with, or in place of the examples described with regard to a corresponding one or more same or similarly named and/or numbered component in any other figure.

Throughout the application, ordinal numbers (e.g., first, second, third) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While examples discussed herein have been described with respect to a limited number of examples, those skilled in the art, having the benefit of this disclosure, will appreciate that other examples can be devised which do not depart from the scope of examples as disclosed herein. Accordingly, the scope of examples described herein should be limited only by the attached claims.

What is claimed is:

1. A computing device, comprising:
one or more processors;
one or more non-transitory computer readable media storing instructions which, when executed by the one or more processors, cause the computing device to:
obtain a sparse distributed memory (SDM) word to be written to a contents matrix;
obtain an address corresponding to the SDM word;
determine a set of activated address rows of an address matrix using the address;
select a set of activated contents matrix rows of the contents matrix based on the set of activated address rows;
calculate a complex value based on an element of the SDM word, wherein an element position of the element corresponds to a contents matrix column pair of the contents matrix; and
for each row of the set of activated contents matrix rows:
modify a real component value of a first column of the contents matrix column pair based on a real part of the complex value; and
modify an imaginary component value of a second column of the contents matrix column pair based on an imaginary part of the complex value.

2. The computing device of claim 1, wherein execution of the instructions further causes the computing device to:
obtain, to read the SDM word, the address corresponding to the SDM word;
determine the set of activated address rows using the address;
select the set of activated contents matrix rows based on the set of activated address rows;
perform an accumulation operation using the set of activated contents matrix rows to obtain an accumulated word; and
perform an angle calculation using an accumulated real part and an accumulated imaginary part of an accumulated word column pair location corresponding to the element of the SDM word to read the element of the SDM word.

3. The computing device of claim 1, wherein:
the SDM word is a vector having n elements, and
n is a positive integer that is greater than or equal to 1.

4. The computing device of claim 3, wherein:
each of the n elements of the word are one of r possible values, and
each of the r possible values is a separate integer value.

5. The computing device of claim 1, wherein the SDM word and the address each comprise an equivalent set of values.

6. The computing device of claim 1, wherein, to determine the set of activated address rows, execution of the instructions further cause the computing device to:
calculate a separate distance value between the address and each row of the address matrix to obtain a set of distance values; and
compare each distance value of the set of distance values to an address activation value to determine the set of activated address rows.

7. The computing device of claim 6, wherein, to compare each distance value of the set of distance values to the address activation value to determine the set of activated address rows to determine the set of activated address rows, execution of the instructions further causes the computing device to:
determine whether each distance value of the set of distance values is less than or equal to the address activation value;
store an activated value for each of a first portion of the set of distance values that are less than or equal to the address activation value; and
store a non-activated value for each of a second portion of the set of distance values that are greater than the address activation value.

8. A computer-implemented method, comprising:
obtaining a sparse distributed memory (SDM) word to be written to a contents matrix;
obtaining an address corresponding to the SDM word;
determining a set of activated address rows of an address matrix using the address;
selecting a set of activated contents matrix rows of the contents matrix based on the set of activated address rows;
calculating a complex value based on an element of the SDM word, wherein an element position of the element corresponds to a contents matrix column pair of the contents matrix; and
for each row of the set of activated contents matrix rows:
modifying a real component value of a first column of the contents matrix column pair based on a real part of the complex value; and
modifying an imaginary component value of a second column of the contents matrix column pair based on an imaginary part of the complex value.

9. The computer-implemented method of claim 8, further comprising:
obtaining, to read the SDM word, the address corresponding to the SDM word;
determining the set of activated address rows using the address;
selecting the set of activated contents matrix rows based on the set of activated address rows;
performing an accumulation operation using the set of activated contents matrix rows to obtain an accumulated word; and
performing an angle calculation using an accumulated real part and an accumulated imaginary part of an accumulated word column pair location corresponding to the element of the SDM word to read the element of the SDM word.

10. The computer-implemented method of claim 8, wherein:
the SDM word is a vector having n elements, and
n is a positive integer that is greater than or equal to 1.

11. The computer-implemented method of claim 10, wherein:
each of the n elements of the word are one of r possible values, and
each of the r possible values is a separate integer value.

12. The computer-implemented method of claim 8, wherein the SDM word and the address each comprise an equivalent set of values.

13. The computer-implemented method of claim 8, wherein determining the set of activated address rows comprises:
calculating a separate distance value between the address and each row of the address matrix to obtain a set of distance values; and
comparing each distance value of the set of distance values to an address activation value to determine the set of activated address rows.

14. The computer-implemented method of claim 13, wherein comparing each distance value of the set of distance values to the address activation value to determine the set of activated address rows to determine the set of activated address rows comprises:
determining whether each distance value of the set of distance values is less than or equal to the address activation value;
storing an activated value for each of a first portion of the set of distance values that are less than or equal to the address activation value; and
storing a non-activated value for each of a second portion of the set of distance values that are greater than the address activation value.

15. A non-transitory computer-readable medium storing programming for execution by a computing device, the programming comprising instructions to:
obtain a sparse distributed memory (SDM) word to be written to a contents matrix;
obtain an address corresponding to the SDM word;
determine a set of activated address rows of an address matrix using the address;
select a set of activated contents matrix rows of the contents matrix based on the set of activated address rows;
calculate a complex value based on an element of the SDM word, wherein an element position of the element corresponds to a contents matrix column pair of the contents matrix; and
for each row of the set of activated contents matrix rows:
modify a real component value of a first column of the contents matrix column pair based on a real part of the complex value; and
modify an imaginary component value of a second column of the contents matrix column pair based on an imaginary part of the complex value.

16. The non-transitory computer-readable medium of claim 15, wherein the programming includes further instructions to:
obtain, to read the SDM word, the address corresponding to the SDM word;
determine the set of activated address rows using the address;
select the set of activated contents matrix rows based on the set of activated address rows;
perform an accumulation operation using the set of activated contents matrix rows to obtain an accumulated word; and
perform an angle calculation using an accumulated real part and an accumulated imaginary part of an accumulated word column pair location corresponding to the element of the SDM word to read the element of the SDM word.

17. The non-transitory computer-readable medium of claim 15, wherein:
the SDM word is a vector having n elements, and
n is a positive integer that is greater than or equal to 1.

18. The non-transitory computer-readable medium of claim 17, wherein:
each of the n elements of the word are one of r possible values, and
each of the r possible values is a separate integer value.

19. The non-transitory computer-readable medium of claim 15, wherein, to determine the set of activated address rows, the programming includes further instructions to:
calculate a separate distance value between the address and each row of the address matrix to obtain a set of distance values; and
compare each distance value of the set of distance values to an address activation value to determine the set of activated address rows.

20. The non-transitory computer-readable medium of claim 19, wherein, to compare each distance value of the set of distance values to the address activation value to determine the set of activated address rows to determine the set of activated address rows, the programming includes further instructions to:
determine whether each distance value of the set of distance values is less than or equal to the address activation value;
store an activated value for each of a first portion of the set of distance values that are less than or equal to the address activation value; and
store a non-activated value for each of a second portion of the set of distance values that are greater than the address activation value.
